(19) United States
(12) Patent Application Publication
(10) Pub. No.: US 2016/0168345 A1
(43) Pub. Date: Jun. 16, 2016

(54) ELASTOMERIC COMPOSITIONS FOR BLOWN-FILM EXTRUSION

(71) Applicants: Frank Eschenbacher, Schnelldorf (DE); Leopoldo V. Cancio, Vero Beach, FL (US)

(72) Inventors: Frank Eschenbacher, Schnelldorf (DE); Leopoldo V. Cancio, Vero Beach, FL (US)

(73) Assignee: Clopay Plastic Products Company, Inc., Mason, OH (US)

(21) Appl. No.: 14/568,648

(22) Filed: Dec. 12, 2014

(51) Int. Cl. C08J 5/18; B29C 47/06; B32B 27/08; B29C 47/00; B32B 27/32; B32B 27/30

(52) U.S. Cl. CPC C08J 5/18; B32B 27/32; B32B 27/302; B32B 27/08; B29C 47/0057; B29C 47/0004; B29C 47/065; C08J 2353/00; C08J 2425/06; C08J 2453/02; B32B 2250/02; B32B 2250/246; B32B 2307/54; B29K 2025/06

(57) ABSTRACT

Improving processability of homogeneous extrusion blown elastomeric films by compatibilizing impact polystyrene in an effective amount with olefin elastomers and styrenic block copolymers.

### FIELD OF THE INVENTION

This invention relates to elastomeric compositions of olefin elastomers and styrenic blocked copolymers with improved processability in blown-film extrusion and homogenous film formation.

### BACKGROUND OF THE INVENTION

Styrenic block copolymers, such as SEBS (styrene-ethylene-butadiene-styrene), SBS (styrene-butadiene-styrene), SEPS (styrene-ethylene-propylene-styrene), SIS (styrene-isoprene-styrene), and SEPS (styrene-ethylene-propylene-styrene) and SEEPS (styrene-ethylene-ethylene-propylene-styrene) are known in the art. They exhibit excellent physical properties, such as elasticity and flexibility. However, they cannot be readily processed on typical polyolefin processing equipment, without the need for flow enhancers and other processing aids. Upon formulation with such materials, end-use properties such as tensile strength and heat resistance can suffer. Furthermore, they can suffer from thermal instability phenomenon such as cross-linking (i.e. SBS) and scission (i.e. SIS).

Olefin elastomers such as olefin block copolymers are readily processable using typical polyolefin processing equipment. They exhibit desirable end-used properties such as high heat resistance and high tensile strength. However, the olefin elastomers and multi-block polymers are not as flexible and elastic as most elastic styrenic block copolymers, especially when used at high strengths. U.S. Pat. No. 7,910,658 discloses blends of olefin block interpolymer compositions and styrenic block copolymers having suitability for elastic compositions with improved processability.

Other patents include U.S. Pat. Nos. 7,355, 089; 7,608,668; 7,714,071; 7,737,215; 7,910,658; 8,273,068; and 8,721,827. These patents disclose an elastomer of at least one ethylene/α-olefin interpolymer elastomer and styrenic block copolymers. U.S. Publication No. 2009/0258210 also discloses an elastomeric film composition comprising at least one olefin elastomeric polymer and at least one draw down polymer in order to produce elastomeric film having a basis weight of no more than about 25 gsm and a permanent set of no more than about 15% after recovery from being stressed to twice its size. The olefin elastomeric polymer can be an olefin block copolymer, olefin random copolymer, ethylene copolymer, propylene copolymer, or mixtures thereof. The olefin elastomers in some embodiments described can also include a styrenic block copolymer. Cast extrusion or blown-film extrusion, and coextrusion processes are known for producing monolayer film and multi-layered film. Thus, it is well known that attempts have been made to blend an olefin elastomer with a styrenic block copolymer and to form films by extruding this combination of elastomers.

Other patents such as U.S. Pat. No. 5,068,138suggest high impact polystyrenes are non-compatible with block copolymers of styrene and butadiene for blown film extrusion. This '138 patent also suggests using polystyrene as a compatible polymer for the block styrene copolymer. Thus, while compositions of olefin elastomers and styrene block copolymers have been employed in blown-film extrusion, there are unpredictabilities in practice for achieving the right combination of components at the right blow up ratios (BUR) to make thinner film meeting desirable specifications.

### SUMMARY OF THE INVENTION

This invention is directed to extrusion blown elastomeric film comprising (i) an olefin elastomer, (ii) a styrenic block copolymer, and (iii) an impact polystyrene in an effective amount to compatibilize the olefin elastomer and the styrenic block copolymer to produce a homogenous film.

The homogeneous film has comparable tensile strengths in the MD and CD that provide balanced properties in the film. Also, MD and high CD properties are obtained that allow for down gauging of the film thereby producing weight saving or thinner films of about 0.5 mil to about 3 mils (about 10 to 75 microns) in thickness. Thinner films permit products to be made at a lower cost and in the hygienic market, the lower cost product is highly advantageous.

In certain embodiments, the homogeneous film has a skin that overlays the elastically extensible film. The skin is formed on at least one of the film's surfaces and may aid in the processability of the homogeneous elastomeric film. In certain embodiments, the skin that overlays the homogeneous elastomeric film comprises an olefin polymer or copolymer and other processing additives as disclosed in the operating examples hereinafter. Non-limiting examples of useful polymeric skin materials include low density polyethylene, high-density polyethylene, linear low density polyethylene, very low density polyethylene, polypropylene homopolymer, copolymers of ethylene and propylene, high impact polystyrene, and combinations thereof. Skin usually has a thickness of about 1 to about 10 microns (about 0.04 to about 0.4 mil), or between about 3-7 microns. Such a skin also provides a surface to the elastomeric film that has less tackiness than the underlying elastomeric film.

Multilayer extrusion blown elastomeric films with two or more layers are also provided by this invention. For example, these films comprise (i) a first layer comprising an olefin elastomer, and (ii) a second layer comprising an olefin elastomer and a styrenic block copolymer and an impact polystyrene, wherein the impact polystyrene is contained in an effective amount to provide a homogeneous multilayer elastomeric film. The first layer can optionally be a skin or outer layer and the second layer of the olefin elastomer styrenic block copolymer and impact polystyrene can be a core layer with opposed olefin elastomer skin layers. These different multilayer products provide different properties in the film products as exemplified in the detailed description hereinafter.

The elastomeric monolayer film or multilayer film generally provides a layer of olefin elastomer in an amount of about 50% to about 75% by weight, styrenic block copolymer in the amount of about 10% to 30% by weight and impact polystyrene in an amount of about 10% to about 20% by weight.

### DETAILED DESCRIPTION OF THE INVENTION

### A. Olefin Elastomer

The thermoplastic olefin elastomer employed in the compositions in this invention is exemplified by olefin block copolymers (OBCs) and ethylene/olefin polymers. Thus, the olefin elastomer can be an olefin block copolymer, olefin random copolymer, ethylene copolymer, propylene copolymer, or mixtures thereof In some embodiments the olefin elastomeric polymer can be ethylene olefin block copolymer, propylene olefin block copolymer, ethylene olefin random copolymer, propylene olefin random copolymer, or mixtures thereof. In other embodiments, the olefin elastomeric polymer can be ethylene-propylene random copolymer, ethylene-butene random copolymer, ethylene-pentene olefin block copolymer, ethylene-hexene random copolymer, ethylene-heptene olefin block copolymer, ethylene-octene olefin block copolymer, ethylene-nonene olefin block copolymer, ethylene-decene olefin block copolymer, propylene-ethylene olefin block copolymer, ethylene α-olefin copolymer, ethylene α-olefin random copolymer, ethylene α-olefin block copolymer, or mixtures thereof Examples of olefin elastomeric polymers are olefin block copolymers (OBCs) which are elastomeric copolymers of polyethylene, sold under the trade name INFUSE™ by The Dow Chemical Company of Midland, Mich. (e.g., INFUSE™ 9107 and 9507). Other examples of olefin elastomeric polymers are copolymers of polypropylene and polyethylene, sold under the trade name VISTAMAXX™ by ExxonMobil Chemical Company of Houston, Tex. (e.g., VISTAMAXX™ 6102).

The olefin elastomeric polymer can be present in an amount to provide or enhance properties (including processing properties) of the olefin layer or of the elastomeric film. The olefin elastomeric polymer can provide better resistance to heat (e.g., increasing the film's heat capacity or thermal stability), compared to, for example, unsaturated styrene block copolymer elastomers. This better resistance to heat can aid in processing or extrusion; for example, a film comprising olefin elastomeric polymers can make it possible to extrude at higher temperatures without significant thermal degradation, at lower viscosity, at a thinner gauge without tearing or pinholing, or combinations thereof Olefin elastomeric polymers can have other enhanced processability characteristics and therefore they can be easier to extrude as thin films. Also, the olefin elastomeric polymers tend to be chemically similar to the polyolefins used for nonwovens. This chemical similarity can improve the chemical affinity between the film layer and nonwoven layer(s) in the laminate. Hence, the laminate can have improved bond strength due to chemical adhesion (e.g., via the chemical similarity) in addition to mechanical bonding.

Patents describing olefin elastomers or olefin block copolymers or olefin-based elastomers include U.S. Pat. Nos. 7,355, 089; 7,608,668; 7,714,071; 7,737,215; 7,910,658; 8,273,068; and 8,721,827. The patents are incorporated herein in their entirety by reference.

### B. Styrenic Block Copolymers

Styrenic block copolymers suitable for use in accordance with this invention, for instance, are block copolymers of vinyl arylene and conjugated diene monomers, such as AB, ABA, ABC, or ABCA block copolymers where the A segments comprise arylenes such as polystyrene and the B and C segments comprise dienes such as butadiene or isoprene. Another group of suitable elastomeric polymers is the block copolymers of vinyl arylene and hydrogenated olefin monomers, such as AB, ABA, ABC, or ABCA block copolymers where the A segments comprise arylenes such as polystyrene and the B and C segments comprise saturated olefins such as ethylene, propylene, or butylene. A styrene block copolymer (SBC), includes but is not limited to, styrene-butadiene-styrene block copolymer (SBS), styrene-isoprene-styrene block copolymer (SIS) (e.g., VECTOR 4211 provided by Dexco Polymers LP of Houston, Tex.), styrene-isoprene-butadiene-styrene block copolymer (SIBS), styrene-ethylenebutylene-styrene block copolymer (SEBS), styrene-ethylene-propylene block copolymer (SEP), styrene-ethylene-propylene-styrene block copolymer (SEPS), styrene-ethylene-ethylene-propylene-styrene block copolymer (SEEPS), or mixtures thereof. Some block copolymers include KRATON® Polymers provided by KRATON Polymers LLC of Houston, Tex. (e.g., Series D polymers (such as SIS or SBS copolymers) or Series G (such as SEBS or SEPS block copolymers)), Dexco Polymers LP of Houston, Tex. (e.g., SBS or SIS block copolymers), and Septon Company of America of Pasadena, Tex. (SEP, SEPS, SEBS, or SEEPS block copolymers).

Examples of styrenic block copolymers suitable for the invention are described in but are not limited to EP0712892 B1; WO204041538 A1; U.S. Pat. No. 6,582,829 B1; US 2004/0087325 A1; US 2004/0122408 A1; US 2004/0122409 A1; U.S. Pat. No. 4,789,699; U.S. Pat. No. 5,093,422; U.S. Pat. No. 5,093,422; U.S. Pat. No. 5,332,613; U.S. Pat. No. 6,916,750 B2; US 2002/0052585 A1; U.S. Pat. No. 6,323,389 B1; and U.S. Pat. No. 5,169,706, which are incorporated by reference for their teachings regarding styrenic block copolymers.

### C. Impact Polystyrene

An impact polystyrene in accordance with the principles of this invention includes polymers generally known as rubber modified polystyrene. Impact polystyrene (IPS) or high impact polystyrene (HIPS) is in an effective compatibilizing amount for the combination of the olefin elastomer and styrenic block copolymer. The impact polystyrene is usually made by polymerizing styrene in the presence of polybutadiene. A two-phase system is formed due to the immiscibility of polystyrene and polybutadiene. Polystyrene forms a continuous phase matrix and polybutadiene is in a dispersed phase (rubber particle). Rubber particles contain small inclusions of polystyrene. In a preferred form of the invention, HIPS is employed as a compatibilizing additive for the elastomeric components of the inventive composition. An example of HIPS is STYRENE® 485 from Dow Chemical of Midland, Mich. The precise reasoning for the surprising effectiveness of HIPS as a compatibilizer in the compositions of this invention is not entirely understood. However, it is believed attributable to the polybutadiene structural graft onto a polystyrene backbone. Whatever the structure, an impact polystyrene represented by HIPS has a dual affinity for each olefin elastomer and styrene block copolymer components of the compositions to facilitate their blown film extrusion.

### D. Relative Amounts of Components

With reference to the detailed operating examples hereinafter, the relative amounts of the components of the inventive composition in the monolayer or multilayer core layer, for example, to achieve the objectives of this invention may vary where the olefin elastomer (such as an OBC), is employed as the base elastomer at about 50% to about 75% by weight. The styrenic block copolymer, such as hydrogenated high molecular weight (SEBS) block copolymer, is usually added at about 10%-30% by weight and where the high impact polystyrene component (HIPS) is employed in an amount of about 10%-20% to compatibilize the elastomeric components of the composition and to improve the processing and end properties of the blown extruded film. Slip and anti-blocking agents are employed to manage blocking and other processing of composition and to increase a cross direction (CD) tensiles. Other additives such as pigments, dyes, antioxidants, antistatic agents, slip agents, foam agents, heat stabilizers, light stabilizers, inorganic fillers, organic fillers or combinations thereof can be added to the amounts of the main components relative to the total weight of the composition usually in an amount about 0.1% to about 0.2%.

### E. Permanent Set and Film Thickness or Basis Weight

“Permanent set” is the increase in length of a sample of a film after the film has been stretched to a given length and then allowed to relax. Permanent set is typically expressed as a percent increase relative to the original size. For example, if a 10 cm piece of elastomeric film is stretched to 20 cm, then allowed to relax, and the resulting relaxed film is 11.5 cm in length, the permanent set of the film is 15%.

The test method used to measure permanent set is based upon ASTM D882-97 with the following details. The sample is cut to make one inch by six inch specimens—the six inch length is in the direction of the film or laminate being tested (e.g., in the CD direction for the examples below). An MTS Tensile Tester (Qtest) is used to measure the sample deformation. The tester grip faces are rubber grip faces that are 25 mm side (MTS part No. 56163829). The sample is loaded with a grip distance set at 50 mm from the center of upper grip face to the center of the lower grip face. The strain endpoint is set to 201%. The first upload cycle is run at a rate of 500 mm to the strain endpoint, then immediately returns to 0% strain at a rate of 500 mm, and then is held at 0% strain for 30 seconds. The second upload cycle is run at a rate of 500 mm to the strain endpoint, and then immediately returns to 0% strain at a rate of 500 mm. The permanent set is calculated at the point when load reaches 0.05 N of force during the second upload cycle.

“Basis weight” is an industry standard term that quantifies the thickness or unit mass of a film or laminate product. The basis weight is the mass per planar area of the sheet-like material. Basis weight is commonly stated in units of grams per square meter (gsm) or ounces per square yard (osy). The elastomeric films of this invention have a permanent set of less than about 25% and thicknesses at about 0.5 mil to about 3 mils (about 10 to 75 microns) to obtain the advantages of thin elastomeric films for many purposes. These thicknesses correspond to basis weights in the usual range of 10 to 70 gsm.

The principles of this invention and its operating parameters will be further understood with reference to the following detailed examples which serve to illustrate the types of specific components of the compositions and their amounts used in polymer formulations suitable for use in blown-film extrusion. These examples are considered to be exemplary of this invention and should not be considered as limiting especially in view of the application's broad disclosure of the invention.

### BRIEF DESCRIPTION OF THE DRAWINGS

The invention will be more fully understood in view of the drawing, FIG. 1, which is a schematic of a typical blown-film coextrusion process. FIG. 2 is a cross-section of an ABC multilayer film produced by the process.

FIG. 1 illustrates a schematic of a blown film coextrusion process for an ABC-type three-layer multi-layer film shown in FIG. 2. Three conventional screw extruders designated A, B and C are employed for the elastomeric film composition comprising a skin layers A and C with core layer B. The molten polymer compositions are then transferred from the extruders to the extrusion die 11 to form the multilayer polymer bubble 12 where the polymer bubble rapidly cools to form the film 10. The film 10 may then pass over optional equipment such as idler rolls 13, 13 which facilitate transfer of film from the blown film extrusion section to a winder where it is wound and stored to await further processing. This process can be modified to make an elastomeric film that is a monolayer elastomeric film in accordance with the principles of this invention. Additional processing steps can be performed on the elastomeric film, such as activating, aperturing, printing, slitting, laminating additional layers to the film, and such other processes. Such other processes are described in the background of this invention detailed above and their disclosures are incorporated herein by reference.

### EXAMPLES 1-8

To illustrate the features of this invention for comparison with other elastomeric compositions, Examples 1-8 were performed. Example 8 discloses the inventive composition of an olefin elastomer, styrenic block copolymer and the impact polystyrene compatibilizer as a coextruded core layer compared with Examples 1-7 to illustrate to the unobvious features of this invention.

### COMPARATIVE EXAMPLE 1

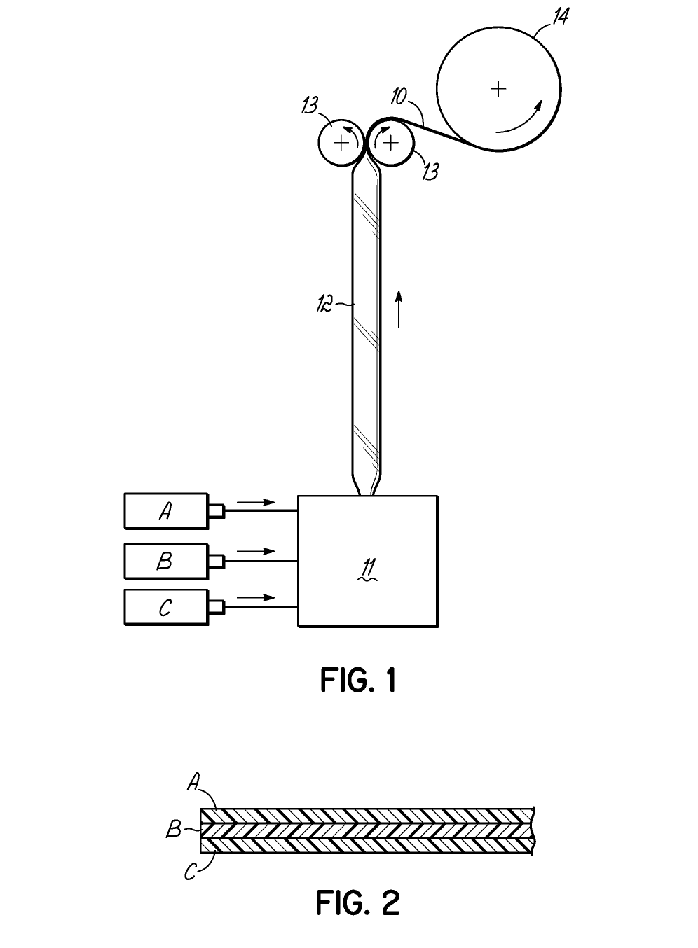

Blown elastomeric film was prepared according to the schematic process of FIG. 1 in the drawing under the conditions set forth in the Table 1, Example 1. The elastomeric film of 50 microns thickness comprised layers of about 20/60/20 of the overall multilayer film A/B/C. The A (skin) layer comprised 82% INFUSE™ 9007 which is an olefin block copolymer of ethene-l-octene copolymer CAS #26221-73-8 with 15% AB1 (anti block agent)+2% slip+1% PPA. The B layer contained 98% INFUSE™ 9007+1% slip+1% PPA. The C layer contained 82% INFUSE™ 9007+15% AB1+2% slip+1% PPA. With reference to Table 1 conditions for blown film extrusion set forth for the resulting ABC structure, the film produced had tensile strengths which were below the target and the permanent set was considered to be above the target and, furthermore, the process produced high polymer build up on the die.¹ ¹ The processing additives used in the examples were as follows: AB: Ingredients: SiO² (natural and synthetic). Talkum, CaCO³, Carrier PS485 Slip: Erucic Acid, Carrier PS485 PPA: Fluorelastomer and/or Fluorpolymer, Carrier PS485

### COMPARATIVE EXAMPLE 2

An extrusion blown elastomeric film of 50 microns was produced according to the schematic of the FIG. 1 of the drawing employing the conditions of Table 1, Example 2, with the 20/60/20 A/B/C multilayer structure of the film where the following amounts of the components were employed: A: 82% 9007+15% AB1+2% slip+1% PPA; B: 98% 9007+1% slip+1% PPA; C: 82% 9007+15% AB1+2% slip+1% PPA.

### COMPARATIVE EXAMPLE 3

An extrusion blown elastomeric film of 50 microns was produced according to the schematic of the FIG. 1 of the drawing employing the conditions of Table 1, Example 3, with the 20/60/20 A/B/C multilayer structure of the film where the following amounts of the components were employed: A: 77% 9007+15% AB1+2% slip+1% PPA; B: 98% 9007+1% slip+1% PPA; C: 82% 9007+15% AB1+2% slip+1% PPA.

### COMPARATIVE EXAMPLE 4

An extrusion blown elastomeric film of 50 microns was produced according to the schematic of the FIG. 1 of the drawing employing the conditions of Table 1, Example 4, with the 13/74/13 A/B/C multilayer structure of the film where the following amounts of the components were employed: A: 78% 9007+18% AB1+3% slip+1% PPA; B: 98% 9007+1% slip+1% PPA; C: 77% 9007+18% AB1+4% slip+1% PPA.

### COMPARATIVE EXAMPLE 5

An extrusion blown elastomeric film of 25 microns was produced according to the schematic of the FIG. 1 of the drawing employing the conditions of Table 1, Example 5, with the 20/60/20 A/B/C multilayer structure of the film where the following amounts of the components were employed: A: 82% 9007+15% AB1+2% slip+1% PPA; B: 98% 9007+1% slip+1% PPA; C: 99% 9007+1% PPA.

### COMPARATIVE EXAMPLE 6

An extrusion blown elastomeric film of 50 microns was produced according to the schematic of the FIG. 1 of the drawing employing the conditions of Table 1, Example 6, with the 20/60/20 A/B/C multilayer structure of the film where the following amounts of the components were employed: A: 82% 9007+15% AB1+2% slip+1% PPA; B: 68% 9007+30% SEBS+1% slip+1% PPA; C: 82% 9007+15% AB1+2% slip+1% PPA.

### COMPARATIVE EXAMPLE 7

An extrusion blown elastomeric film of 50 microns was produced according to the schematic of the FIG. 1 of the drawing employing the conditions of Table 1, Example 7, with the 20/60/20 A/B/C multilayer structure of the film where the following amounts of the components were employed: A: 82% 9007+15% AB1+2% slip+1% PPA; B: 63% 9007+20% SEBS+15% Additive 1+1% slip+1% PPA; C: 82% 9007+15% AB1+2% slip+1% PPA. “Additive 1” was polystyrene Dow 678 general purpose polystyrene.

### INVENTIVE EXAMPLE 8

An extrusion blown elastomeric film of 50 microns was produced according to the schematic of the FIG. 1 of the drawing employing the conditions of Table 1, Example 8, with the 20/60/20 A/B/C multilayer structure of the film where the following amounts of the components were employed: A: 82% 9007+15% AB1+2% slip+1% PPA; B: 63% 9007+20% SEBS+15% Additive 2+1% slip+1% PPA; C: 82% 9007+15% AB1+2% slip+1% PPA.

An evaluation of Examples 1-8 demonstrates that Example 8 employing the extrusion blown elastomeric film of this invention of an olefin elastomeric and styrenic block copolymer containing an impact polystyrene compatibilizer (“Additive 2”) produced a homogeneous film with good properties. “Good properties” are understood to mean a low permanent set percentage of less than 18, and good CD properties, characterized by an Fpeak value of greater than 20. Such properties are exemplified in Table 2, Example 15.

In contrast, the products of Examples 1-7 without the compatibilizing HIPS additive for the olefin elastomer and styrene block copolymer produced elastomeric film where the permanent set that was too high and the tensiles were too low (Example 1); or too sticky (Example 2); or where the permanent set was too high as in the case of Examples 3 and 4; where the tensiles may have been better in the case of Example 5, but the film produced was inhomogeneous and lacked commercial properties in the case of Examples 5-7. Also in the case of Example 7, the use of the polystyrene (DOW polystyrene 678) produced in an inhomogeneous film.

Therefore, Examples 1-8 illustrate the inventiveness and unpredictability of making extrusion blown elastomeric films and the unexpected advantages of employing an impact polystyrene in an effective amount to compatibilize the olefin elastomer and the styrenic block copolymer to form a homogeneous film. In the case of the multi-layer product of Example 8, the extrusion blown elastomeric film comprised a core layer of an olefin elastomer and a styrenic block copolymer containing the impact polystyrene compatibilizer in an effective amount to produce the homogeneous film having good properties.

TABLE 1

| Condition | Unit | Ex. 1 | Ex. 2 | Ex. 3 | Ex. 4 | Ex. 5 | Ex. 6 | Ex. 7 | Ex. 8 |
|---|---|---|---|---|---|---|---|---|---|
| Amps - Ext. A | A | 2.6 | 3.1 | 2.8 | 2.7 | 3.1 | 2.7 | 2.7 | 2.7 |
| Amps - Ext. B | A | 5.8 | 6.9 | 4 | 8.3 | 6.9 | 6.9 | 6.9 | 6.9 |
| Amps - Ext. C | A | 4.7 | 5.2 | 4 | 4.3 | 4.7 | 5.3 | 5.3 | 5.3 |
| B.U.R. | | 2 | 3.2 | 3.2 | 3.2 | 3.2 | 3.2 | 3.2 | 3.2 |
| Die gap | mm | 2.4 | 2.4 | 2.4 | 2.4 | 2.4 | 2.4 | 2.4 | 2.4 |
| Layer Percentage - | % | 20 | 20 | 20 | 13 | 20 | 20 | 20 | 20 |
| Ext. A | | | | | | | | | |
| Layer Percentage - | % | 60 | 60 | 60 | 74 | 60 | 60 | 60 | 60 |
| Ext. B | | | | | | | | | |
| Layer Percentage - | % | 20 | 20 | 20 | 13 | 20 | 20 | 20 | 20 |
| Ext. C | | | | | | | | | |
| Melt Pressure - | bar | 120 | 155 | 115 | 117 | 144 | 110 | 112 | 114 |
| Ext. A | | | | | | | | | |
| Melt Pressure - | bar | 215 | 264 | 233 | 303 | 254 | 260 | 239 | 249 |
| Ext. B | | | | | | | | | |
| Melt Pressure - | bar | 117 | 145 | 233 | 303 | 254 | 260 | 239 | 249 |
| Ext. C | | | | | | | | | |
| Melt Temperature - | Deg C. | 209 | 209 | 207 | 209 | 209 | 212 | 212 | 212 |
| Ext. A | | | | | | | | | |
| Melt Temperature - | Deg C. | 213 | 210 | 208 | 212 | 211 | 210 | 208 | 210 |
| Ext. B | | | | | | | | | |
| Melt Temperature - | Deg C. | 215 | 215 | 211 | 214 | 215 | 215 | 215 | 215 |
| Ext. C | | | | | | | | | |
| RPM - Ext. A | rpm | 22 | 29 | 28 | 22 | 29 | 29 | 29 | 29 |
| RPM - Ext. B | rpm | 36 | 45 | 45 | 73 | 45 | 45 | 45 | 45 |
| RPM - Ext. C | rpm | 11 | 14 | 14 | 11 | 14 | 14 | 14 | 14 |
| Structure | | A/B/C | A/B/C | A/B/C | A/B/C | A/B/C | A/B/C | A/B/C | A/B/C |
| Take-off speed | m/min | 5.2 | 4.2 | 4.8 | 6.1 | 9.6 | 4.5 | 4.5 | 4.5 |
| Total Output | kg/h | 5.5 | 7 | 7 | 9 | 7 | 7 | 7 | 7 |
| Total Thickness | um | 50 | 50 | 50 | 50 | 50 | 50 | 50 | 50 |

### EXAMPLES 9-15

To further illustrate the monolayer extruded blown film practice of the invention, Examples 10-15 were performed as set forth in Table 2. Employing a composition of an olefin elastomer without a compatibilizer in Examples 10-11 produced a monolayer film for comparison with monolayer films having the compatibilizing additive of an impact polystyrene as in Examples 12-15 hereinafter as follows. In Example 10, 40% of the olefin block copolymer (INFUSE™ 9507) was employed with 60% Vector 4111, a styrene-isoprene-styrene (SIS) block copolymer from Dexco Polymer LP of Houston Tex. The extrusion blown elastomeric film produced in accordance with this example was inhomogeneous and unacceptable from a commercial standpoint and produced tensiles in the cross direction of the film that were considered to be low i.e. on the order of about 11-12 N/inch.

In contrast, when the olefin block copolymer and styrenic block copolymer were compatibilized with an amount of impact polystyrene (DOW 485 HIPS), homogeneous elastomeric films were produced having acceptable cross direction tensiles on the order of about 19-24 N/inch and the film produced was homogeneous. In the case of Example 12, 65% of the OBC 9507 was employed with 20% SEBS and 15% impact polystyrene (DOW 485 HIPS). In the case of Example 13, 75% OBC 9507 was employed with 10% SEBS and 15% impact polystyrene (DOW 485 HIPS). In the case of Example 14, 60% of the OBC 9107 was employed with 25% SEBS and 15% impact polystyrene (DOW 485 HIPS). In the case of Example 15, 70% of OBC 9107 was employed with 15% SEBS and 15% impact polystyrene (DOW 485 HIPS).

Thus, employing the impact polystyrene compatibilizer in the extrusion blown processing of elastomeric film compositions of olefin block copolymers and styrenic block copolymers as exemplified by Examples 12-15, suitable homogeneous films were produced having improved cross directional strengths on the order of 20-24 N/inch.

TABLE 2

| | | | | | | Test Method Hysteresis | | | |
|---|---|---|---|---|---|---|---|---|---|
| | | Test Method Tensile Strength | | | | CD | | | |
| | | MD | | CD | | F_{Load} | F_{Load} | F_{Unload} | Permanent |
| | | Fₚₑₐₖ | Elongation_{Peak} | Fₚₑₐₖ | Elongation_{Peak} | @ 100% | @200% | @ 150% | Set |
| | | [N/Inch] | [%] | [N/Inch] | [%] | 1st Cycle | 1st Cyle | 2nd Cycle | [%] |
| Ex | Composition | >20 | >500 | >20 | >1300 | [N/Inch] | [N/Inch] | [N/Inch] | <18 |
| 9 | 100% OBC 9507 | 16.47 | 1347.75 | 14.02 | 1450.87 | 1.40 | 4.07 | 1.25 | 33.95 |
| | | 19.30 | 1487.41 | 12.87 | 1498.34 | 1.47 | 4.02 | 1.29 | 34.14 |
| | | 15.59 | 1366.82 | 9.97 | 1229.42 | 1.43 | 4.12 | 1.30 | 33.75 |
| Average | | 17.12 | 1400.66 | 12.29 | 1392.88 | 1.43 | 4.07 | 1.28 | 33.95 |
| 10 | 40% OBC 9507 | 25.14 | 1203.92 | 12.08 | 1362.75 | 1.19 | | 1.87 | 20.45 |
| | 60% Vector 4111 | 22.77 | 1136.70 | 12.80 | 1417.20 | 1.09 | 3.98 | 1.63 | 19.30 |
| | | 20.31 | 1096.12 | 13.24 | 1471.19 | 1.03 | 3.78 | 1.56 | 18.37 |
| Average | | 22.74 | 1145.58 | 12.71 | 1417.05 | 1.10 | 3.88 | 1.69 | 19.37 |
| 11 | 90% OBC 9507 | 25.32 | 1355.55 | 16.23 | 1419.00 | 1.07 | 4.07 | 1.88 | 16.24 |
| | 10% SEBS | 25.37 | 1272.42 | 9.84 | 1188.51 | 1.05 | 4.54 | 1.90 | 16.22 |
| | | 18.33 | 1080.03 | 7.91 | 1119.20 | 1.13 | 5.40 | 1.95 | 16.64 |
| Average | | 23.01 | 1236.00 | 11.33 | 1242.24 | 1.08 | 4.67 | 1.91 | 16.37 |
| 12 | 65% OBC 9507 | 20.16 | 1184.65 | 18.38 | 1484.41 | 1.14 | 6.26 | 1.71 | 20.21 |
| | 20% SEBS | 18.22 | 1102.90 | 20.08 | 1496.71 | 1.20 | 4.99 | 1.78 | 21.77 |
| | 15% DOW 485 HIPS | 21.45 | 1188.04 | 19.65 | 1537.06 | 1.17 | 4.86 | 1.78 | 20.87 |
| Average | | 19.94 | 1158.53 | 19.37 | 1506.06 | 1.17 | 5.37 | 1.76 | 20.95 |
| 13 | 75% OBC 9507 | 24.23 | 948.37 | 20.62 | 1369.48 | 1.47 | 7.03 | 2.47 | 16.99 |
| | 10% SEBS | 22.61 | 932.60 | 16.36 | 1274.68 | 1.20 | 5.90 | 2.07 | 15.49 |
| | 15% DOW 485 | 19.80 | 728.28 | 18.39 | 1272.86 | 1.22 | 4.98 | 2.08 | 15.93 |
| Average | | 22.21 | 869.75 | 18.46 | 1305.67 | 1.30 | 5.97 | 2.21 | 16.14 |
| 14 | 60% OBC 9107 | 26.92 | 779.40 | 15.78 | 1071.40 | 1.56 | 7.96 | 2.38 | 20.62 |
| | 25% SEBS | 23.25 | 440.89 | 30.76 | 1303.58 | 1.31 | 6.47 | 2.02 | 20.22 |
| | 15% DOW 485 | 27.52 | 810.35 | 26.83 | 1337.28 | 1.33 | 6.10 | 2.06 | 21.42 |
| Average | | 25.90 | 676.88 | 24.46 | 1237.42 | 1.40 | 6.84 | 2.15 | 20.75 |
| 15 | 70% OBC 9107 | 28.52 | 1322.03 | 24.98 | 1531.29 | 1.02 | 4.85 | 2.07 | 14.52 |
| | 15% SEBS | 24.73 | 1078.95 | 22.95 | 1445.43 | 1.00 | 4.60 | 2.00 | 14.20 |
| | 15% DOW 485 | 25.90 | 1074.52 | 24.25 | 1522.88 | 0.93 | 4.25 | 1.85 | 13.96 |

| | | | | | | | | |
|---|---|---|---|---|---|---|---|---|
| Average | 26.38 | 1158.50 | 24.06 | 1499.87 | 0.98 | 4.57 | 1.97 | 14.23 |

The above data and experimental results demonstrate the unique properties of the elastomeric films of this invention and other variations will be apparent to a person of skill in the art without departing from this invention.

What is claimed is:

1. An extrusion blown elastomeric film having a length (MD) and width (CD) comprising
i. an olefin elastomer,
ii. a styrenic block copolymer, and
iii. an impact polystyrene in an effective amount to compatibilize said olefin elastomer and said styrenic block copolymer to form a homogenous film with comparable tensile strengths in the MD and CD.

2. The elastomeric film of claim 1 wherein at least one surface of the elastomeric film is provided with a skin overlying the elastomeric film.

3. The elastomeric film of claim 1 wherein said olefin elastomer is selected from the group consisting of olefin block copolymer, olefin random copolymer, ethylene copolymer, propylene copolymer, and mixtures thereof.

4. The elastomeric film of claim 1 wherein said olefin elastomer is selected from the group consisting of ethylene olefin block copolymer, propylene olefin block copolymer, ethylene olefin random copolymer, propylene olefin random copolymer, and mixtures thereof.

5. The elastomeric film of claim 1 wherein said olefin elastomer is selected from the group consisting of ethylene-propylene random copolymer, ethylene-butene random copolymer, ethylene-hexene random copolymer, ethylene-octene olefin block copolymer, propylene-ethylene olefin block copolymer, ethylene α-olefin copolymer, ethylene α-olefin random copolymer, ethylene α-olefin block copolymer, and mixtures thereof.

6. The elastomeric film of claim 1, wherein said styrenic block copolymer is selected from the group consisting of styrene-butadiene-styrene block copolymer, styrene-isoprene-styrene block copolymer, styrene-isoprene-butadiene-styrene block copolymer, styrene-ethylenebutylene-styrene block copolymer, styrene-ethylene-propylene block copolymer, styrene-ethylene-propylene-styrene block copolymer, styrene-ethylene-ethylene-propylene-styrene block copolymer, and mixtures thereof.

7. The elastomeric film of claim 1 wherein said olefin elastomer is present in an amount of about 50% to about 75% by weight, said styrenic block copolymer is present in the amount of about 10% to 30% by weight and said impact polystyrene is present from about 10% to about 20% by weight.

8. The elastomeric film of claim 1 having a thickness of about 0.5 mil to about 3 mils (about 10 to 75 microns).

9. The elastomeric film of claim 8 having a permanent set of less than about 25%.

10. The elastomeric film of claim 2 wherein said skin comprises a polymer selected from the group consisting of low density polyethylene, high-density polyethylene, linear low density polyethylene, very low density polyethylene, a polypropylene homopolymer, copolymers of ethylene and propylene, high impact polystyrene, and combinations thereof.

11. The elastomeric film of claim 2 wherein said skin comprises an olefin polymer or copolymer and has a thickness of about 0.04 mil to about 0.4 mil (about 1 micron to about 10 microns).

12. A multilayer elastomeric film with two or more layers comprising
i. a first layer comprising an olefin elastomer, and
ii. a second layer comprising a styrenic block copolymer and an impact polystyrene in an effective amount to form a homogeneous multilayer elastomeric film.

13. The elastomeric film of claim 12 wherein said olefin elastomer is selected from the group consisting of olefin block copolymer, olefin random copolymer, ethylene copolymer, propylene copolymer, and mixtures thereof.

14. The elastomeric film of claim 12 wherein said olefin elastomer is selected from the group consisting of ethylene olefin block copolymer, propylene olefin block copolymer, ethylene olefin random copolymer, propylene olefin random copolymer, and mixtures thereof.

15. The elastomeric film of claim 12 wherein said olefin elastomer is selected from the group consisting of ethylene-propylene random copolymer, ethylene-butene random copolymer, ethylene-hexene random copolymer, ethylene-octene olefin block copolymer, propylene-ethylene olefin block copolymer, ethylene α-olefin copolymer, ethylene α-olefin random copolymer, ethylene α-olefin block copolymer, and mixtures thereof.

16. The elastomeric film of claim 12, wherein said styrenic block copolymer is selected from the group consisting of styrene-butadiene-styrene block copolymer, styrene-isoprene-styrene block copolymer, styrene-isoprene-butadiene-styrene block copolymer, styrene-ethylenebutylene-styrene block copolymer, styrene-ethylene-propylene block copolymer, styrene-ethylene-propylene-styrene block copolymer, styrene-ethylene-ethylene-propylene-styrene block copolymer, and mixtures thereof.

17. The elastomeric film of claim 12 wherein said olefin elastomer is present in an amount of about 50% to about 75% by weight, said styrenic block copolymer is present in the amount of about 10% to 30% by weight and said impact polystyrene is present from about 10% to about 20% by weight.

18. The elastomeric film of claim 12 having a thickness of about 0.5 mil to about 3 mils (about 10 to 75 microns).

19. The elastomeric film of claim 18 having a permanent set of less than about 25%

20. The elastomeric film of claim 12 wherein said first layer has a skin overlaying the olefin elastomer.

21. The elastomeric film of claim 20 wherein said skin comprises a polymer selected from the group consisting of low density polyethylene, high-density polyethylene, linear low density polyethylene, very low density polyethylene, a polypropylene homopolymer, copolymers of ethylene and propylene, high impact polystyrene, and combinations thereof.

22. The elastomeric film of claim 20 wherein said skin comprises an olefin polymer or copolymer and has a thickness of about 0.04 mil to about 0.4 mil (about 1 micron to about 10 microns).

23. A method for making an extrusion blown elastomeric film comprising mixing an olefin elastomer, a styrenic block copolymer, and an impact polystyrene in an effective amount to compatibilize said olefin elastomer and said styrenic block copolymer, and
blow extruding said mixture into an elastomeric film.

24. The method of claim 23 wherein said olefin elastomer is selected from the group consisting of olefin block copolymer, olefin random copolymer, ethylene copolymer, propylene copolymer, and mixtures thereof and wherein said styrenic block copolymer is selected from the group consisting of styrene-butadiene-styrene block copolymer, styrene-isoprene-styrene block copolymer, styrene-isoprene-butadiene-styrene block copolymer, styrene-ethylenebutylene-styrene block copolymer, styrene-ethylene-propylene block copolymer, styrene-ethylene-propylene-styrene block copolymer, styrene-ethylene-ethylene-propylene-styrene block copolymer, and mixtures thereof.

25. The method of claim 24 wherein said olefin elastomer is present in an amount of about 50% to about 75% by weight, said styrenic block copolymer is present in the amount of about 10% to 30% by weight and said impact polystyrene is present from about 10% to about 20% by weight.

26. A method for making a multilayer elastomeric film with at least two layers comprising coextruding a first and a second layer wherein
i. the first layer comprises an olefin elastomer, and
ii. a second layer comprises a styrenic block copolymer and an impact polystyrene in an effective amount to form a homogeneous multilayer elastomeric film.

27. The method of claim 26 wherein the second layer comprises a core layer and said first layer comprises a skin overlaying said olefin elastomer on at least one side of said core layer.

28. The method of claim 27 wherein said skin comprises a polymer selected from the group consisting of low density polyethylene, high-density polyethylene, linear low density polyethylene, very low density polyethylene, a polypropylene homopolymer, copolymers of ethylene and propylene, high impact polystyrene, and combinations thereof.

29. The method of claim 26 wherein said olefin elastomer is selected from the group consisting of ethylene-propylene random copolymer, ethylene-butene random copolymer, ethylene-hexene random copolymer, ethylene-octene olefin block copolymer, propylene-ethylene olefin block copolymer, ethylene α-olefin copolymer, ethylene α-olefin random copolymer, ethylene α-olefin block copolymer, and mixtures thereof and wherein said styrenic block copolymer is selected from the group consisting of styrene-butadiene-styrene block copolymer, styrene-isoprene-styrene block copolymer, styrene-isoprene-butadiene-styrene block copolymer, styrene-ethylenebutylene-styrene block copolymer, styrene-ethylene-propylene block copolymer, styrene-ethylene-propylene-styrene block copolymer, styrene-ethylene-ethylene-propylene-styrene block copolymer, and mixtures thereof.

30. The method of claim 26 wherein said elastomeric film has a thickness of about 0.5 mil to about 3 mils (about 10 to 75 microns) and a permanent set of less than about 25%.
